(19) United States
(12) Patent Application Publication
(10) Pub. No.: US 2002/0035569 A1
(43) Pub. Date: Mar. 21, 2002

(54) Construction of virtual objects based on run-time type information

(76) Inventors: Phillip Clark, Sandy, UT (US); Lori Clark, Sandy, UT (US)

Correspondence Address: Kevin K. Johanson, WORKMAN, NYDEGGER & SEELEY, 1000 Eagle Gate Tower, 60 East South Temple, Salt Lake City, UT, 84111, US

(21) Appl. No.: 09/952,972

(22) Filed: Sep. 14, 2001

Related U.S. Application Data
(60) Provisional application No. 60/233,070, filed on Sep. 15, 2000.

(51) Int. Cl. G06F 17/30

(52) U.S. Cl. 707/102; 707/103 R

(57) ABSTRACT

A method for creating object-type specifications for virtual and partially virtual objects is presented wherein virtual objects may specify an external source for their internal state. This virtual state of an object may come from more than one external source. The method is implemented by creating object type specifications for virtual objects, registering object-type specifications for all objects that participate in virtual objects, and providing an object factory where collaborators can obtain virtual objects as needed. With regard to creating object-type specifications for virtual objects, the present invention maps the data item of one object to the data item of another object through the use of a query of run-time type-information (RTTI) to obtain the complete metadata for both objects which must be known.

### CROSS-REFERENCE TO RELATED APPLICATIONS

The present application claims priority from and is a continuation-in-part of U.S. Provisional Patent Application No. 60/233,070, entitled EXTENSIBLE DEVELOPMENT PLATFORM, which was filed on Sep. 15, 2000, and is hereby incorporated by reference in its entirety. Additionally, the present application is related to and includes the disclosure of Assignee's co-pending U.S. Patent Application Ser. No. ______, entitled EXTENSIBLE SOFTWARE DEVELOPMENT USING ASYNCHRONOUS MESSAGING (Attorney Docket No. 15016.30), which is hereby incorporated by reference in its entirety; and Assignee's co-pending U.S. Patent Application Ser. No. ______, entitled EXTENDED ASYNCHRONOUS MESSAGING (Attorney Docket No. 15016.33), which is hereby incorporated by reference in its entirety.

### BACKGROUND OF THE INVENTION

1. The Field of the Invention

This invention generally relates to object-oriented programming, and particularly, objects that are composites of other objects already known to the system.

2. The Relevant Technology

Software computer programming highly invests in the concept of re-use of software components. In order to more greatly facilitate such re-use, programming architectures partition software applications into components or other smaller and more manageable blocks or portions of software. Furthermore, data elements are reused across multiple code segments or components for efficiency and for commonality throughout the software program. In an object-oriented programming architecture, such data elements have assumed various names including the term “object.” For clarity, differentiation is presented between “objects” that represent things that can be described, such as people, birds, or vehicles; and “objects” that primarily represent a logical or algorithmic process, such as a “compression provider,” “registration manager,” “object store,” etc.

The objects that represent “things” tend to have a real-world analogs and are called “data objects.” The other type of objects are classified as “logic objects” and may be considered to be components or logical partitions of computer software generally specializing in solving a limited aspect of the problem being solved. Logic objects, while being thought of as components, may also be thought of as finer grained objects making up the combined logic of a component. For the sake of simplicity, the present discussion does not indulge in the semantic of whether or not data objects also implement logic.

In a typical software system, many fine-grained data objects exist. Often, these data objects make up the consumable artifacts that a logic object uses when collaborating with other logic objects. It is appreciated that in relationship to data objects, certain notions or concepts regarding such objects are appreciated. First, the concept of “visibility” implies that a data object is “known” to other components or collaborators. Similarly, the concept of “ownership” implies a determination of which component has primary responsibility for the lifespan management of the data object. FIG. 1 illustrates the concepts of visibility and ownership. It should be appreciated that in order for related components or collaborators to interact, an “object type specification” or class for each data object employed in an interaction between collaborators must be known among all collaborators that make use of those data objects. In the present example of FIG. 1, an exemplary “eLearning component” 100 must include an object type specification for exemplary person objects 102 and course objects 104 in order to use the instances of person and course during collaboration.

By way of example, an object type specification must declare the publicly accessible features of an object which may include data items and collaboration points. Of general interest during collaboration are data items which are often called or known as attributes or fields. Generally speaking, data items represent the internal state of an object. For example, FIG. 2 illustrates an object type specification of a person object 102 as defined by a person object type specification 120 which specifies that a person is composed of a first name, last name, social security number, date of birth, phone number, and mailing address data items. Additionally, an address object is comprised of an address object type specification 130 composed of street address, county, city, state, country, and postal code data items. In the example, the two object type specifications, 120 and 130, are related since the person object type specification 120 includes as a data item and address object type specification 130. In other words, the two object type specifications are related because the person class “has” an address.

In typical programming, it is commonplace for another component in the same system to have requirements for the same information as already specified in a first component, but in a different composition. For instance, FIG. 3 illustrates an exemplary phone book component having an object type specification 140 that is defined to include data items common from both person object type specification 120 and address object type specification 130. In such a scenario, one or the other of the components is chosen for modification in order to avoid the complexity of maintaining redundant sets of objects in two separate components. In such a scenario, the components are dependent on the composition of data objects as specified by the collaborator.

In prior attempts, others have attempted to achieve a similar effect by producing “adapter objects” which may contain references to one or more other objects that are called in order to fulfill the requests that are made on the adapter. For example, FIGS. 4 and 5 illustrate two components in a system, a Person component 150 and a Phone Book component. Each of the components are in need of “person” data. In order to reduce the need for maintaining two sets of objects that must be synchronized, it is possible to implement the Phone Book Person object 160 such that it can make use of the existing Person object 150.

Therefore, it would be desirable to be able to specify an object type specification such that data items making up the state of the object are supplied by other objects in the system.

### BRIEF SUMMARY OF THE INVENTION

The present invention solves the need for virtual objects by providing a mechanism for sharing data items with trusted collaborators such that virtual objects may be declared and requested, constructed and retrieved. The present invention provides a mechanism for creating object-type specifications for virtual and partially virtual objects. Present invention further provides object-type specifications wherein virtual objects may specify an external source for their internal state. This virtual state of an object may come from more than one external source. Furthermore, when a virtual state is obtained from multiple external sources, the associations among the sources may be specified in a manner that may be thought of as joinery. Furthermore, instances of virtual objects are immutable in order to protect the source objects from data transformations that may violate the source objects' integrity. Additionally, the present invention provides a generic class factory for obtaining instances of virtual objects.

The present invention provides a method for (1) creating object type specifications for virtual objects, (2) registering object-type specifications for all objects that participate in virtual objects, and (3) providing an object factory where collaborators can obtain virtual objects as needed. With regard to creating object-type specifications for virtual objects, the present invention maps the data item of one object to the data item of another object through the use of a query of run-time type-information (RTTI) to obtain the complete metadata for both objects which must be known. The present invention provides an extension of existing deficiencies in programming language primitives by providing utility and adaptor classes that may be used to indicate the additional information necessary for object-to-object mappings.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a component diagram demonstrating a sharing of objects;

FIG. 2 illustrate an object type specification of several objects;

FIG. 3 illustrates an object type specification derived from other objects;

FIG. 4 illustrates an object type specification through the use of adapter objects;

FIG. 5 is a flow diagram of the adapter-type definition of an object type specification as illustrated in FIG. 4;

FIG. 6 is a sequence diagram of the method for mapping a data item of one object to the data item of another object through the use of metadata and extended metadata, in accordance with the preferred embodiment of the present invention;

FIG. 7 is a hierarchy diagram of an object having a relationship with another object;

FIG. 8 is a sequence diagram representative of a specific implementation of the present invention;

FIG. 9 illustrates two objects exhibiting commonality in that one object is introduced by another and may rely upon the virtual object mapping method, in accordance with the present invention; and

FIG. 10 illustrates the collaboration triggered by a request for an instance of an object, in accordance with a preferred embodiment of the present invention.

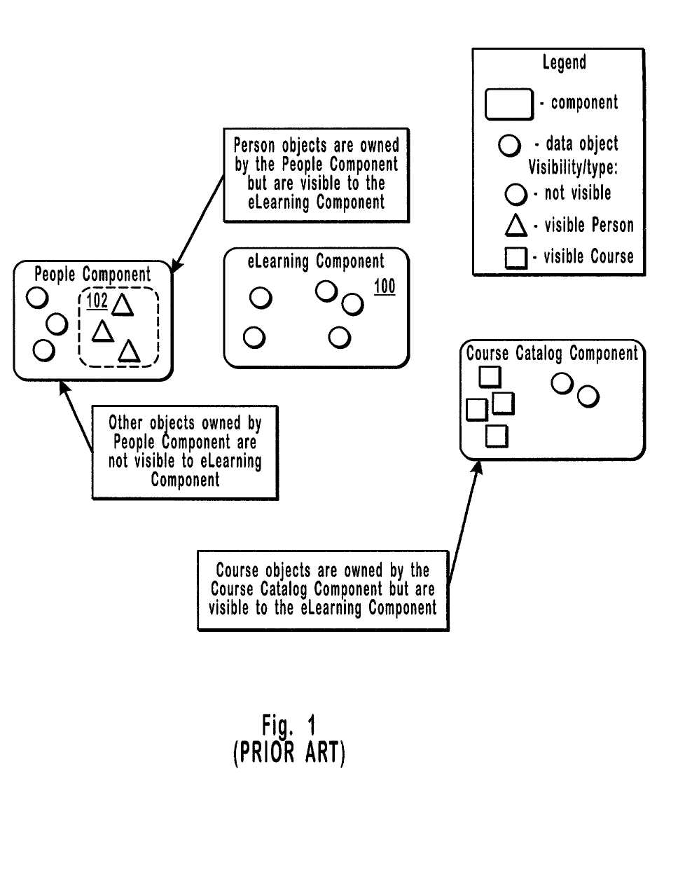

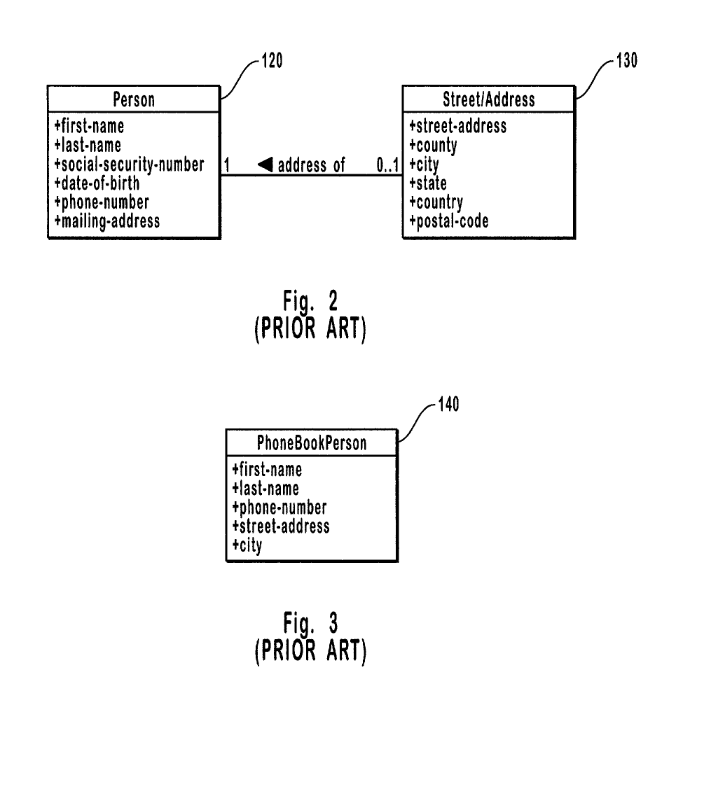

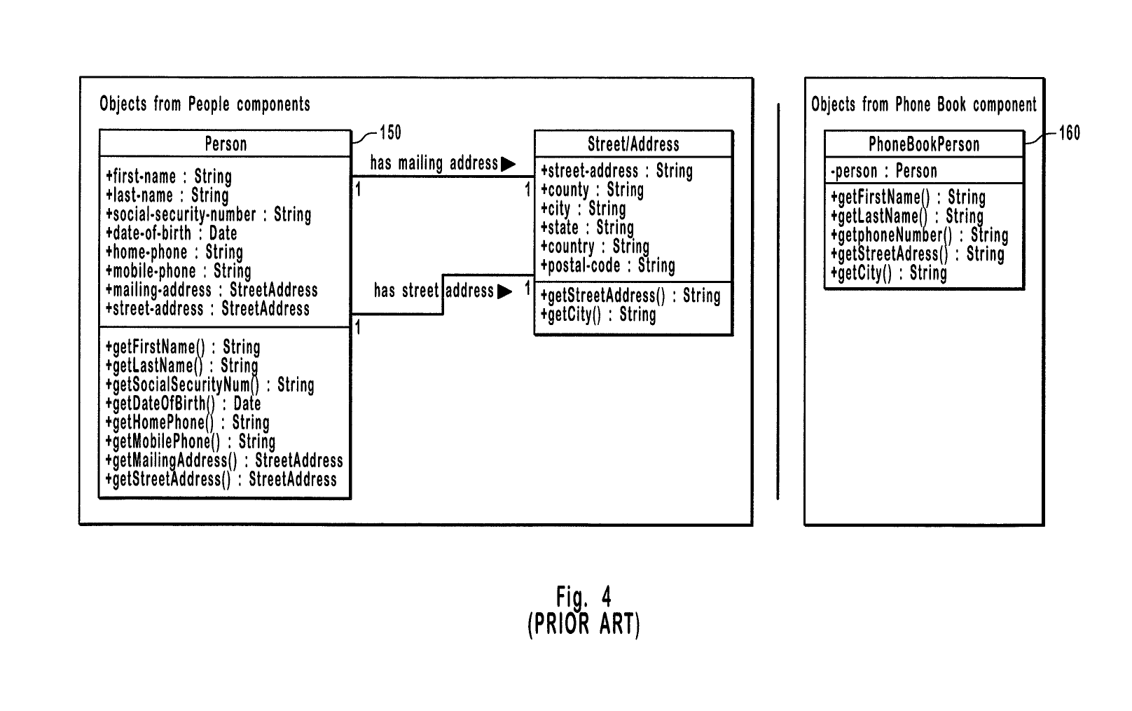

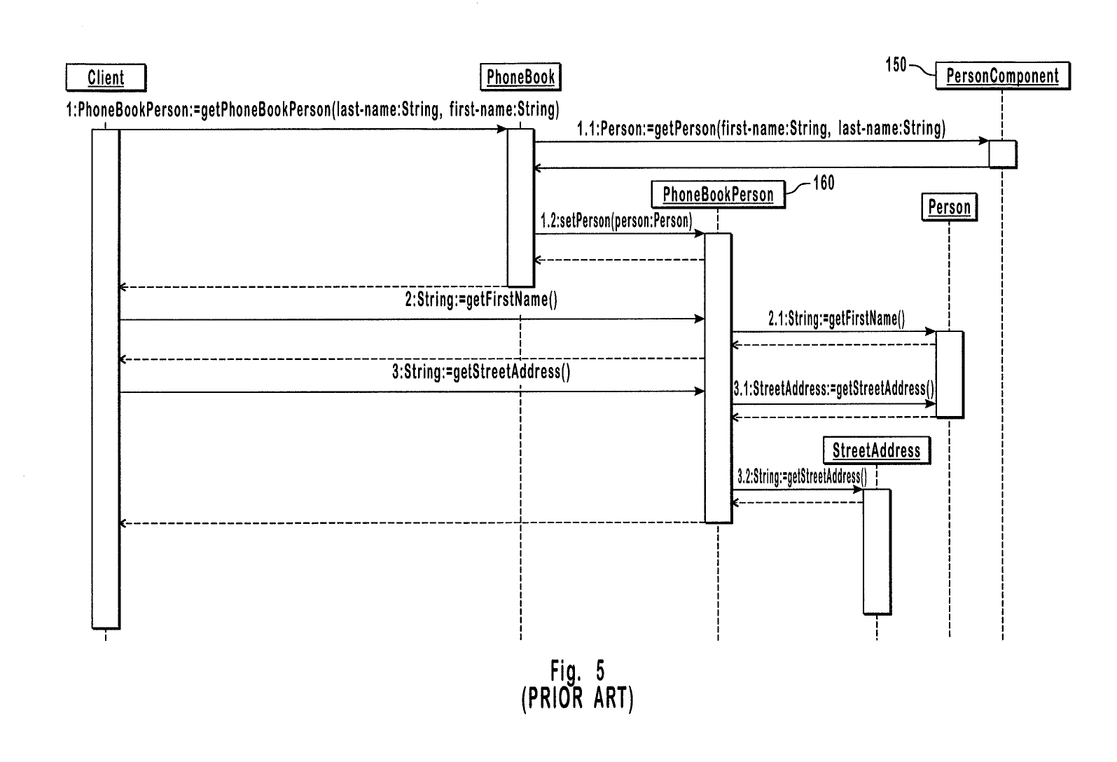

### DETAILED DESCRIPTION OF THE PREFERRED EMBODIMENTS

The present invention solves the need for virtual objects by providing a mechanism for sharing data items with trusted collaborators such that virtual objects may be declared and requested, constructed and retrieved. The present invention provides a mechanism for creating object-type specifications for virtual and partially virtual objects. The present invention further provides object-type specifications wherein virtual objects may specify an external source for their internal state. The virtual state of an object may come from more than one external source. Furthermore, when a virtual state is obtained from multiple external sources, the associations among the sources may be specified in a manner may be thought of as joinery. Furthermore, instances of virtual objects are immutable in order to protect the source objects from data transformations that may violate the source objects' integrity. Additionally, the present invention provides a generic class factory for obtaining instances of virtual objects. The present invention provides a method for (1) creating object type specifications for virtual objects, (2) registering object-type specifications for all objects that participate in virtual objects, and (3) provide an object factory where collaborators can obtain virtual objects as needed.

With regard to creating object-type specifications for virtual objects, the present invention maps the data item of one object to the data item of another object through the use of a query of run-time type-information (RTTI) to obtain the complete metadata for both objects which need be known. The present invention provides an extension of existing deficiencies in programming language primitives that provide object-to-object mappings through utility and adaptor classes that may be used to indicate the additional information necessary for object-to-object mappings.

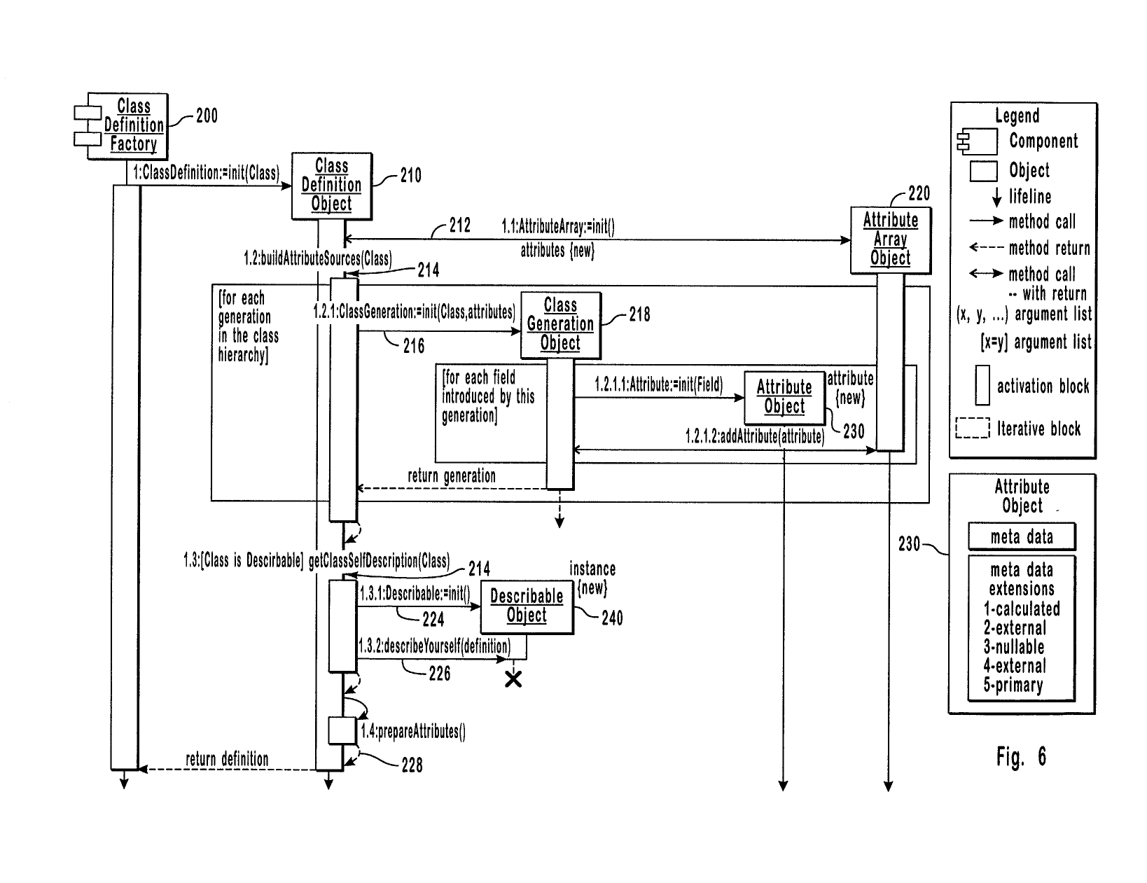

FIG. 6 illustrates the afore-described mapping of such an implementation. FIG. 6 illustrates a flow diagram for extending the metadata which in the exemplary embodiment relies upon RTTI. In FIG. 6, a class definition factory 200 provides a facade class that allows access to the extended metadata. The metadata is available per object type specification (class.) Class definition 210 is an encapsulation of the metadata for the use by the class factories and providers of virtual objects. This class maintains a list of data items, also interchangeably referred to as “fields” or “attributes,” in an attribute array object 220.

In the exemplary implementation, class definition 210 queries the RTTI for the metadata already known about the class. Class definition 210 performs the task of extending the metadata and further defining the class. Class definition 210 carries out the following steps:

1. In step 212, Class Definition object 210 constructs an Attribute Array object 220 to hold the attribute objects.

2. Class Definition object 210 identifies each class in a class hierarchy in a step 214; that is to say, Class Definition object 210 identifies super classes within the class hierarchy.

3. For each class in the hierarchy, Class Definition object 210 in a step 216 constructs a Class Generation object 218 which in turn builds a list of attributes and adds them to the attribute array 220.

4. Class Definition object 210 constructs an instance of the class being further defined in a step 222 and a step 224.

5. Class Definition object 210 in a step 226 asks the class to describe itself.

6. Class Definition object 210 in a step 228 prepares the attributes according to the extended metadata.

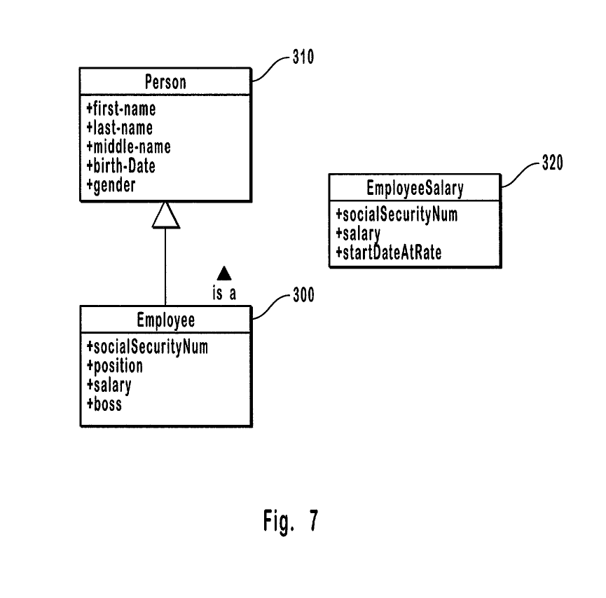

7. Class Generation object 218 represents a particular generation in the class hierarchy. For instance, in FIG. 7, the Employee object 300 is a specialization of Person object 310 which is the classic “is a” relationship, as depicted in FIG. 7, wherein Employee is a subclass of Person. By way of example, if Class Definition object 210 encountered the Employee object type specification, it would construct two Class Generation objects, one for Employee and one for the super class Person.

8. Class generation 218 interrogates RTTI to determine which data items are introduced by the class that it represents. For each data item instructed, an attribute object 230 is added to the attribute array 220 supplied by the Class Definition object 210.

Returning to FIG. 6, the attribute object 230 represents a data item that is specified for a particular generation of class. In an embodiment that employs RTTI, information relating to the name of the data item which, for example, in FIG. 7 is the social security number, position, salary, or boss of the employee class, the type of the data item including the specific data type and whether such type is a primitive or abstract.

Additionally, Attribute object 230 of FIG. 6 includes the operations necessary to extend the metadata. Such extensions include: 1—Calculated, 2—External, 3—Nullible, 4—Indexed, and 5—Primary. The calculated extension is a descriptor that indicates that the attribute represents a calculated value and does not have an external source although the attribute itself may be an external source. The external extension is a descriptor that indicates the attributes represent a calculated value and does not have an external source although the attribute itself may be an external source. The external descriptor is a descriptor that indicates the attribute has an external source and is therefore virtual in nature, meaning that its value is owned by another object and mapped to the present object under construction. The nullable extension is a descriptor that indicates that “non-value” is a valid value for the attribute. The index extension is a descriptor that indicates that the attribute will be used in constraints used to obtain instances of the virtual object. The primary extension is a descriptor that indicates that the attribute is indexed and that it participates in uniquely distinguishing among other object instances.

Still referring to FIG. 6, Attribute Array object 220 is a container object created by the Class Definition object 210 and shared by Class Definition object 210 and Class Generation object 218 in order to maintain the extended metadata for a class.

The metadata extension as depicted in FIG. 6 further includes a Describable object 240 which functions as an “interface” that enables a class for interrogation. Through the Describable object 240 interface, the Class Definition object 210 can call back to an instance of the class itself to supply the additional metadata. In this manner, the author of the class maintains responsibility for the definition and behavior of the class. FIG. 6 further illustrates a “describe yourself” method call 226 which, for example, assumes the objects introduced in FIG. 7. In this particular message sequence, the Employee class is illustrated as extending the metadata to indicate that the “salary” data item is a virtual data item. Returning to FIG. 6, regarding the Describable object 240, in method call 224, Class Definition object 210 constructs a new instance of the class being described by the collaboration. In a method 226, Class Definition object 210 calls the “describe yourself” method implemented by the class being described and passes in a reference to itself so that the class has access to metadata.

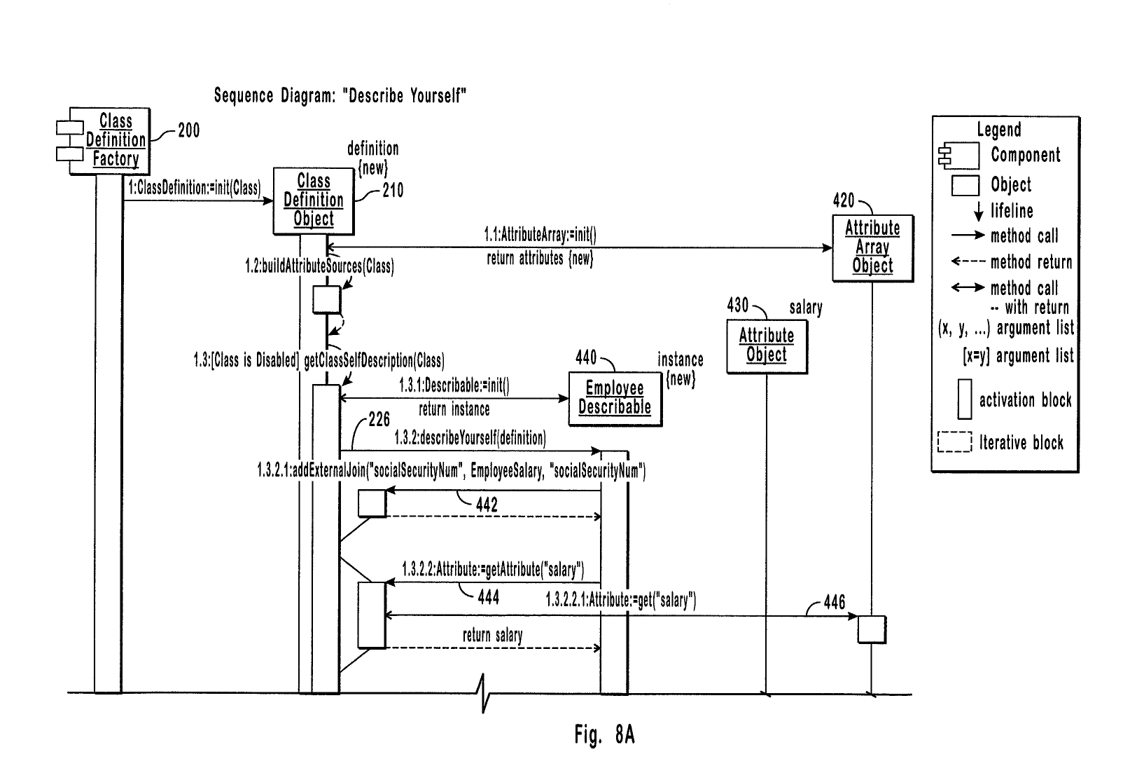

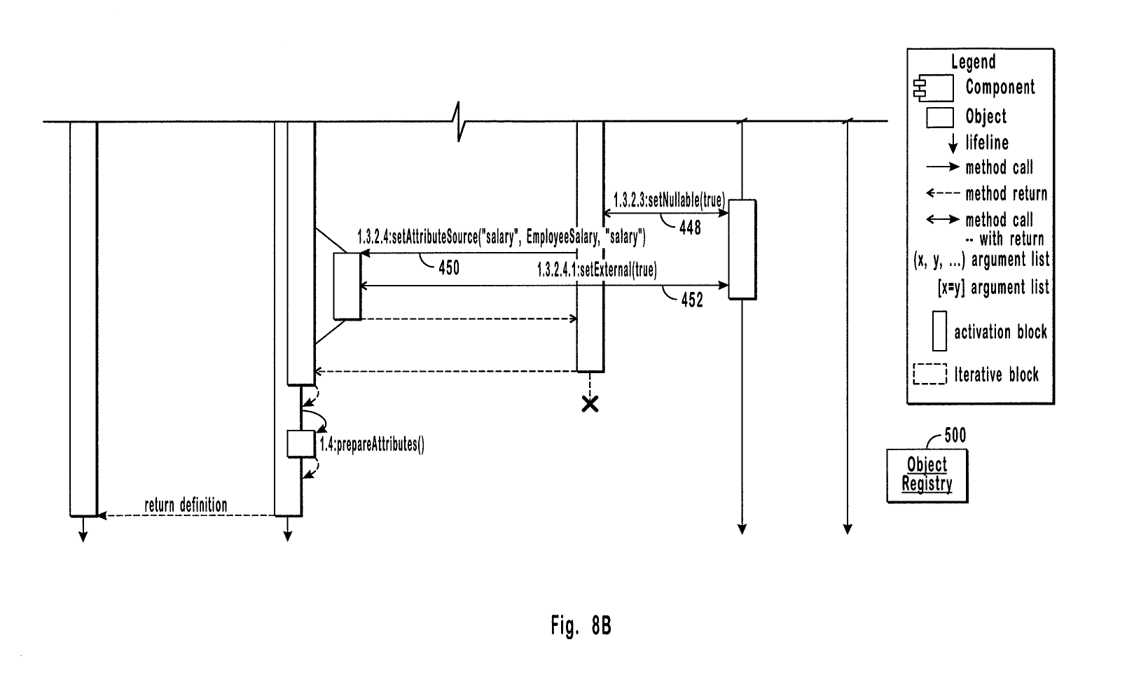

FIG. 8 illustrates the sequence diagram for the “describe yourself” method call 226 which for example assumes the objects introduced in FIG. 7. In this particular message sequence, the Employee class is illustrated as extending the metadata to indicate that the “salary” data item is a virtual data item. In the present example of FIG. 8, the Employee class calls the “add external join” method 442 implemented by the Class Definition object 210 to indicate that it can be associated with instances of the “Employee Salary” class 320 (FIG. 7) that match its “social security number” data item. In a method call 444, employee class calls the “get attribute” method implemented by the Class Definition object 210 to obtain a reference to the “salary” attribute. In a method call 446, Class Definition object 210 calls the “get” method implemented by the Attribute Array object 420 to obtain a reference to the “salary” attribute which it returns to the Employee object 440.

In method call 448, the Employee object calls the “set nullable” method of the Attribute object 430 to indicate that the salary attribute is an optional data item meaning that no-value is valid. In a method call 450, the Employee object calls the “set attribute source” method implemented by the Class Definition object 210 to indicate that the salary attribute is a virtual and therefore external data item to be retrieved from an instance of “employee salary” if one exists that matches the joinery established in method call 442. In method call 452, the class definition object 210 calls the “set external” method of the attribute object 430 to indicate that the salary attribute is external.

It should be noted that the method calls depicted in FIG. 8 are used as an example of a representation of the Java implementation for conveying an example indicative of the present invention, while other implementations are also contemplated within the scope of the present invention. Furthermore, the “describable” interface described above is not a requirement for obtaining a class definition meaning an extension of the metadata for an object type specification but is rather included for an example of how an interface may be implemented.

It should be recalled that operation of the present invention involves creating an object type, which has been described above and also registering the object type specifications for all objects that participate in virtual objects. The complete and extended metadata for all virtual object participants must be known by the Object Factory object 600 in order to facilitate the construction and composition of virtual objects. To make such complete metadata available, the present invention employs an object registry 500 (FIG. 8) for this purpose.

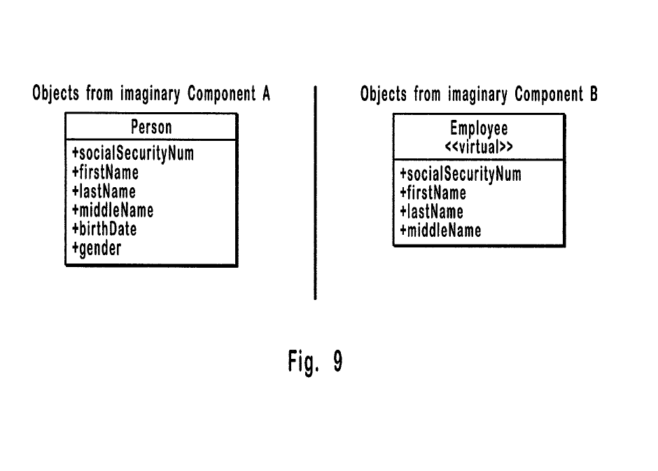

Due to the nature of virtual objects, a mechanism must exist that can construct and compose these objects from the other objects available. The present invention employs a component called an Object Factory for such a purpose. An Object Factory differs from a class factory in that it can construct and obtain objects of any type registered with the virtual object system as long as a unique piece of information is known about the object to be retrieved. For example, consider the two objects in FIG. 9, an Employee object and a Person object. FIG. 9 illustrates an Employee object introduced by one component and a Person object introduced by another component. In examples such as this, where there is an integration to be built between two components that have similar object structures, virtual objects provide a means by which redundancies can be reduced. Such a reduction is particularly important when objects need to persist between executions.

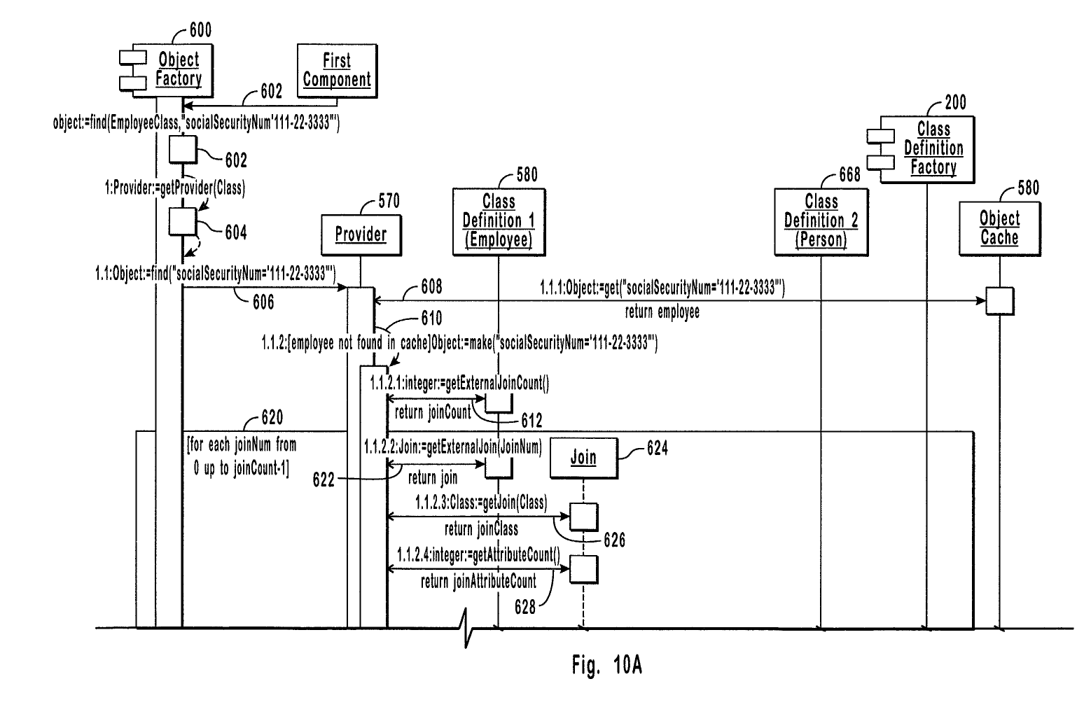

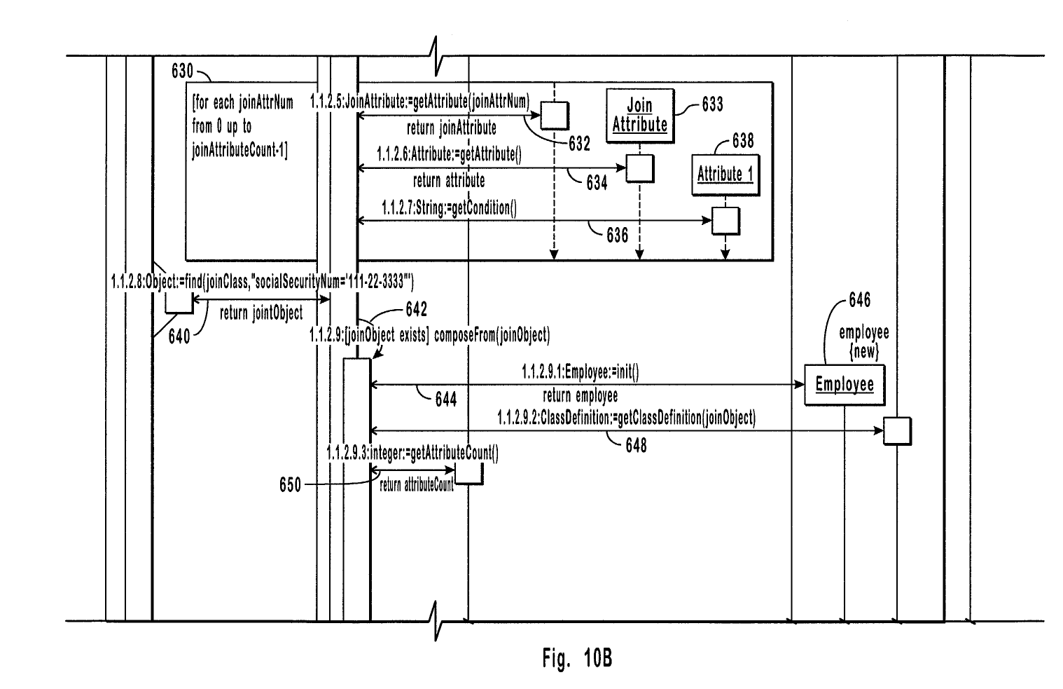

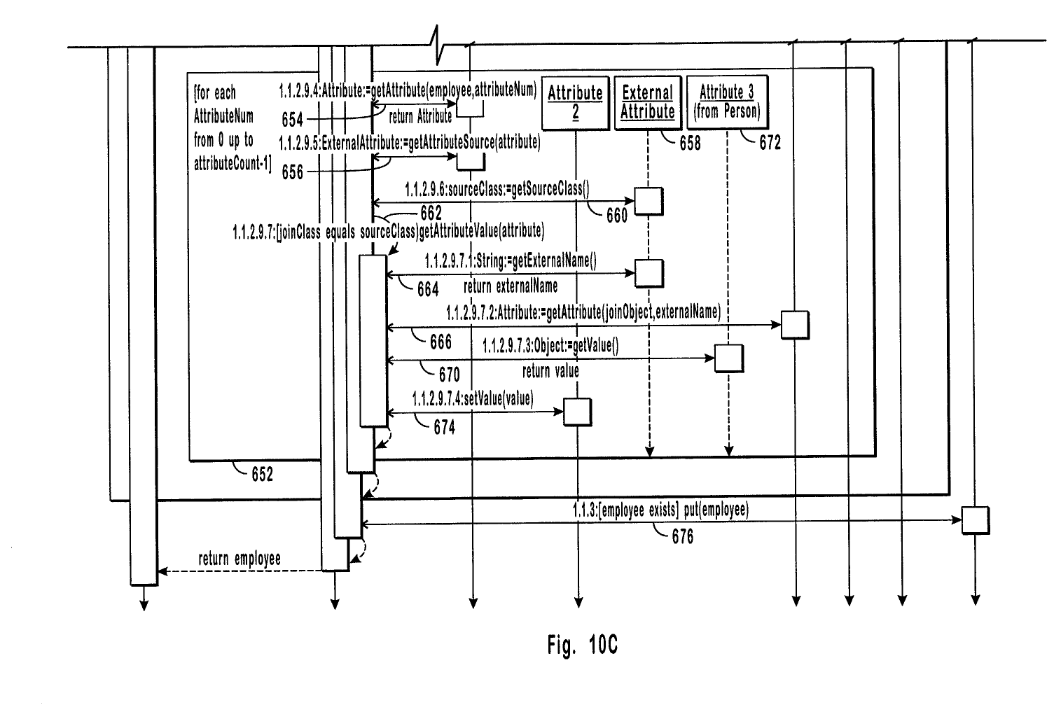

FIG. 10 illustrates the collaboration triggered by a request for an instance of the Employee object from FIG. 7. It is important to understand that Employee is a pure virtual object, meaning that it does not own any of its own data items. This is a simple case for the sake of illustration as a virtual object generally will be composed of data items from more than one object, and such is contemplated within the scope of the present invention.

Returning to FIG. 10, an employee with the social security number of 111-222-3333 is being requested. In the present example of FIG. 10, an object calling the “find” method of the Object Factory 600 initiates the process in a step 602. In a step 604, the Object Factory 600 maintains a keyed list of Providers, one for each class that is registered. For virtual classes, the provider is supplied by the virtual object system. If the class is not a virtual class, the provider is plugged into the Object Factory 600 so that it can call back to the owner of the class to obtain instances. In either case, the Class Definition Factory component 200 has a Class Definition for the class. The Object Factory 600 checks to see if there is a Provider for the class requested by calling the “get” provider method.

Following the method call 604, a method call 606 finds the Object Factory component 600 delegating the “find” request to the provider. In a method call 608, depending on the provider implementation, the Provider object 570 checks in object cache to see if there is an object already composed that would fulfill the request. This checking is accomplished by calling the “get” method of the cache. If there is such an object then it is returned from the cached object 580.

A method call 610 is implemented when the object did not exist, such as in the case of Employee, the Provider object 570 calls its own “make” method in order to create or retrieve one. In a method call 612, the Provider object 570 either maintains a reference to the Class Definition for the classes for which it provides, or obtains them from the Class Definition Factory 200 as needed. Provider object 570 called the “get external join count” method in order to determine how many classes the Employee Class has associated therewith.

The following loop, defined herein as loop 1, having the reference numeral 620 is performed for each associated class as a join function. In a method call 622, the Provider object 570 retrieves the next Join object 624 from the Class Definition object 580 by calling the “get external join” method. In a method call 626, the Provider object 570 retrieves the target of the association represented by the Join object 624 by calling the “get join class” method of the Join object 624. In a method call 628, a provider object 570 retrieves from the Join object 624 the number of attributes that participate in the join by calling the “get attribute count.” The obtained attributes are the attributes of the Employee that have an associated attribute on the target of the association.

For each of the participating attributes, a loop 630 is performed. In loop 630, a method call 632, initiated by the Provider object 570, retrieves from the Join object 624 the next Join Attribute by calling the “get attribute” method. Join attributes represent each specific attribute that participates in the join. Loop 630 further includes a method call 634 wherein the Provider object 570 retrieves from the Join attribute the local attribute by calling the “get attribute” method. Loop 630 further includes a method call 634 wherein the Provider object 570 retrieves from the Join attribute the local attribute by calling the “get” method. From the perspective of a join, attributes are either local or external. Local attributes are those defined in the current classes, while external attributes are those at the other end of the association. It should be pointed out that if the name of the local attribute matches one of the find conditions given, the value given in the find condition is communicated to the Attribute by a call to the “set value.” Loop 630 further comprises a method call 636 wherein the Provider object 570 retrieves a conditional statement from the Attribute object 638. One exemplary implementation of the Object Factory component 600 and Provider objects 570, support SQL/92 syntax or other similar syntax for conditional statements. In the present example, we consider a conditional statement as part of an SQL statement following the “where” clause in the outer statement.

Following the interactive approach of Loop 630, a method call 640 issued by Provider object 570 to Object Factory component 600 retrieves any associated objects and provides decoupling of components participating in virtual objects by reducing the explicit knowledge that each must know about providers of objects which are typically components. In method call 640, Provider object 570 calls the “find” method of the Object Factory component 600 to obtain the joined object. The Provider object passes the class obtained in method call 626 so that the Object Factory component 600 can retrieve the desired type of object and the conditional statement constructed in loop 630.

If method call 640 returns an object, in this case a Person, then the Provider object 570 proceeds with constructing a new virtual object. In FIG. 10, such a construction is indicated by the Provider object 570 calling a “compose from” method on itself. In a method call 644, the Provider object constructs a new “hollow” Employee object 646. In a method call 648, the Provider object 570 uses the Class Definition Factory 200 to obtain the Class Definition from the “join object” object. In a method call 650, Provider object 570 uses the Class Definition in the present example for Employee to determine the number of attributes that are defined.

An iterative loop 652 is executed for each defined attribute. In a method call 654, Provider object uses the Class Definition, in the present example for Employee, to obtain the next defined attribute by calling the “get attribute” method. In a method call 656, the Provider object uses Class Definition, in the present example for Employee, to obtain the external source definition for the attribute by calling the “get attribute source” method, passing the attribute returned from method call 654. The external source is represented by an External Attribute object 658. In a method call 660, Provider object 570 uses the External Attribute object 658 to obtain the class of the external attribute source. In a method call 662, if the current join class obtained in method call 626 and the attributes source from method call 660 refer to the same class, then the Provider object 570 calls in an internal method called “get attribute value” to establish a value for the attribute retrieved in a method call 654.

In a method call 664, the Provider object uses the External Attribute object 658 to obtain the name of the source attribute on the external object. In a method call 666, the Provider object 570 uses the class definition object for Person to obtain the source attribute by calling the “get attribute” method. The result of method call 640, in the present example join object, is used as a first parameter. This parameter indicates the external object from which to take the attribute. The resulted method call 664 is used as the second parameter. This parameter indicates which attribute should be retrieved.

In method call 670, provider object 570 uses the attribute from Person object 672 to obtain a value object by calling the “get value” method. In a method call 674 provider object 570 establishes a new value for the attribute retrieved from employee in method call 654 by calling that object's “set value” method which concludes processing of loop 652.

In a method call 676, depending upon the provider object implementation, the provider object may optionally retain a reference to a requested object in an Object Cache 580. Such an approach is accomplished by calling the “put” method of the Cache.

The present invention solves the need for virtual objects by providing a mechanism for sharing data items with trusted collaborators such that virtual objects may be declared and requested, constructed and retrieved. The present invention provides a mechanism for creating object-type specifications for virtual and partially virtual objects. The present invention further provides object-type specifications wherein virtual objects may specify an external source for their internal state. The virtual state of an object may come from more than one external source. Furthermore, when a virtual state is obtained from multiple external sources, the associations among the sources may be specified in a manner may be thought of as joinery. Furthermore, instances of virtual objects are immutable in order to protect the source objects from data transformations that may violate the source objects' integrity. Additionally, the present invention provides a generic class factory for obtaining instances of virtual objects. The present invention provides a method for (1) creating object type specifications for virtual objects, (2) registering object-type specifications for all objects that participate in virtual objects, and (3) provide an object factory where collaborators can obtain virtual objects as needed.

What is claimed is:

1. A method for creating a virtual object having at least one data item derived from first object, comprising the steps of:
a. defining a class definition object to provide access to metadata and extended metadata, said extended metadata facilitating mapping between said at least one data items of said another object and virtual data items of said virtual object; and
b. for each of said virtual data items of said virtual object, establishing a mapping between said virtual data items of said virtual object and said at least one data item of said first object.

2. In a object oriented program, a method for mapping at least one attribute of at least one data item from a first object to a virtual object having a virtual class, comprising the steps of:
a. defining a class factory object to provide access to metadata and extended metadata, said extended metadata facilitating mapping between first attributes of said first object and virtual attributes of said virtual object; and
b. defining a class definition object comprised of said metadata for use by said class factory object in providing said virtual object.

3. The method, as recited in claim 2, wherein said defining said class definition object comprises the step of:
a. constructing an attribute array object to hold said virtual attributes of said virtual object.

4. The method, as recited in claim 3, wherein said defining said class definition object comprises the steps of:
a. identifying each class in a class hierarchy of said virtual class of said virtual object; and
b. for each of said class in said class hierarchy,
i. constructing a class generation object which builds a list of said virtual attributes and adds said virtual attributes to said attribute array object.

5. The method, as recited in claim 4, wherein said constructing a class generation object further includes:
a. querying said metadata and said extended metadata for each of said virtual attributes; and
b. constructing an attribute object and adding said attribute object to said attribute array object.

6. The method, as recited in claim 5, wherein said extended metadata includes:
a. a calculated descriptor that indicates that said virtual attribute represents a calculated value; and
b. an external descriptor that indicates that said virtual attribute has an external source.

7. The method, as recited in claim 6, wherein said extended metadata further includes:
a. a nullable descriptor that indicates that said virtual attribute has null as a valid value for said virtual attribute; and
b. an indexed descriptor that indicates that the attribute will be used in constraints used to obtain instances of said virtual object.

8. The method, as recited in claim 4, wherein said defining said class definition object comprises the step of:
a. constructing an instance of said virtual class.

9. The method, as recited in claim 8, wherein said defining said class definition object comprises the steps of:
a. populating said instance of said virtual object with said metadata; and
b. preparing said virtual attributes of said virtual object as directed by said extended metadata.

10. The method, as recited in claim 2, wherein said method for mapping further comprises the step of:
a. registering said metadata and said extended metadata or said virtual object in an object registry for access by said object factory object for construction and composition of other objects.

11. A computer-readable medium having computer-executable instructions for mapping at least one attribute of at least one data item from a first object to a virtual object having a virtual class, said instructions performing the steps of:
a. defining a class factory object to provide access to metadata and extended metadata, said extended metadata facilitating mapping between first attributes of said first object and virtual attributes of said virtual object; and
b. defining a class definition object comprised of said metadata for use by said class factory object in providing said virtual object.

12. The computer-readable medium, as recited in claim 11, comprising computer-executable instructions for performing the step of defining said class definition object, further comprises computer-executable instructions for performing the step of:
a. constructing an attribute array object to hold said virtual attributes of said virtual object.

13. The computer-readable medium, as recited in claim 12, comprising computer-executable instructions for performing the step of defining said class definition object, further comprises computer-executable instructions for performing the steps of:
a. identifying each class in a class hierarchy of said virtual class of said virtual object; and
b. for each of said class in said class hierarchy,
i. constructing a class generation object which builds a list of said virtual attributes and adds said virtual attributes to said attribute array object.

14. The computer-readable medium, as recited in claim 13, wherein said computer-executable instructions for performing the step of constructing a class generation object further includes computer-executable instructions for performing the steps of:
a. querying said metadata and said extended metadata for each of said virtual attributes; and
b. constructing an attribute object and adding said attribute object to said attribute array object.

15. The computer-readable medium, as recited in claim 14, wherein said computer-executable instructions for defining said class definition object further includes computer-executable instructions defining said extended metadata to include:
a. a calculated descriptor that indicates that said virtual attribute represents a calculated value; and
b. an external descriptor that indicates that said virtual attribute has an external source.

16. The computer-readable medium, as recited in claim 15, wherein said computer-executable instructions for defining said class definition object further includes computer-executable instructions defining said extended metadata to include:
a. a nullable descriptor that indicates that said virtual attribute has null as a valid value for said virtual attribute; and
b. an indexed descriptor that indicates that the attribute will be used in constraints used to obtain instances of said virtual object.

17. The computer-readable medium, as recited in claim 13, wherein said computer-executable instructions for performing the step of defining said class definition object comprises computer-executable instructions for performing the step of:
a. constructing an instance of said virtual class.

18. The computer-readable medium, as recited in claim 17, wherein said computer-executable instructions for performing the step of defining said class definition object comprises computer-executable instructions for performing the steps of:
a. populating said instance of said virtual object with said metadata;
and
b. preparing said virtual attributes of said virtual object as directed by said extended metadata.

19. The computer-readable medium, as recited in claim 11, wherein said computer-executable instructions for performing the step of mapping further comprises computer-executable instructions for performing the step of:
a. registering said metadata and said extended metadata or said virtual object in an object registry for access by said object factory object for construction and composition of other objects.
